(19) United States
(12) Patent Application Publication
(10) Pub. No.: US 2007/0284777 A1
(43) Pub. Date: Dec. 13, 2007

(54) Fabrication apparatus and method of fabricating a soft mold

(75) Inventors: Jin-Wuk Kim, Gyeonggi-do (KR); Yeon-Heui Nam, Gangwon-do (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 11/811,703

(22) Filed: Jun. 12, 2007

(30) Foreign Application Priority Data
Jun. 13, 2006 (KR) P 2006-0053127

(51) Int. Cl. B29C 33/40; B29C 71/00; B29C 35/08

(52) U.S. Cl. 264/225; 264/236; 264/494; 425/174.4; 425/385

(57) ABSTRACT

A fabrication apparatus and method use a mold for forming a pattern. The fabrication may be related to a thin film transistor (TFT) used for a switching element and a driving element in a display device, such as a liquid crystal display (LCD) or organic electroluminescent display (OELD). The fabrication method and apparatus fabricate a soft mold using a resin layer that is attached to a back plane in substantially a vacuum environment. The resin layer may be irradiated with ultraviolet (UV) light and then detached from a master plate to form a desired pattern. The fabrication process is such that the soft mold is relatively thin and light-weight, but resistant to being damaged.

The present application claims the benefit of Korean Patent Application 2006-0053127 filed in Korea on Jun. 13, 2006, which is hereby incorporated by reference. This application is related to the patent application entitled “SOFT MOLD AND METHOD OF FABRICATING THE SAME,” (Atty. Dkt. No. 12576/7080 {F07-0088}), Ser. No. ______, filed on ______.

### BACKGROUND

1. Field of the Disclosure

The present disclosure relates to a mold for forming a pattern, and more particularly to a fabrication apparatus and a method for fabricating a soft mold.

2. Discussion of the Related Art

Generally, a thin film transistor (TFT) is used for a switching element and a driving element of a liquid crystal display (LCD) device and an organic electroluminescent display (OELD) device. A fabricating method of the TFT is explained with reference to FIGS. 1A to 1G. FIGS. 1A to 1G are cross-sectional views showing a fabricating process of a TFT according to the related art.

FIGS. 1A and 1B show a first mask process. As shown in FIG. 1A, a first metal layer 12 is formed on a substrate 10 by depositing a first metallic material. The first metallic material may include one of aluminum (AL) or aluminum alloy (AlNd). A first photoresist (PR) layer 14 is formed on the first metal layer 12 by coating a PR material. The PR material may be categorized as either a positive type or a negative type. In the positive type, an irradiated portion of the PR layer is removed by a developing process exposing the PR layer. Contrary to the positive type, an irradiated portion of the PR layer remains after the developing process in the negative type. As shown, the positive type PR material is used. A first mask M having a transmitting portion A and a blocking portion B is disposed over the first PR layer 14, and the first PR layer 14 is exposed to light through the first mask M. The transmitting portion A has transmittance greater than that of the blocking portion B. For example, the transmittance of the transmitting portion A is about 100%, and the transmittance of the blocking portion B is about 0%.

The PR layer 14 is then developed, and an exposed portion of the first PR layer 14 is removed to form a first PR pattern 16 on the first metal layer 12. The first metal layer 12 except for a portion under the first PR pattern 16 is exposed. As shown in FIG. 1C, the exposed first metal layer 12 is etched using the first PR pattern 16 as an etching mask to form a gate electrode 18 on the substrate 10. After the first PR pattern 16 is removed, a gate insulating layer 20 is formed on entire surface of the substrate including the gate electrode 18.

FIG. 1D shows a second mask process. An intrinsic amorphous silicon layer (not shown) and an impurity-doped amorphous silicon layer (not shown) are sequentially formed on the gate insulating layer 20. The intrinsic amorphous silicon layer (not shown) and the impurity-doped amorphous silicon layer (not shown) are patterned using a second mask (not shown) as a patterning mask to form an active layer 22 and an ohmic contact pattern 24 on the gate insulating material 20. The active layer 22 and the ohmic contact pattern 24 correspond to the gate electrode 18. The active layer 22 is formed of amorphous silicon (a—Si:H), and the ohmic contact pattern 24 is formed of impurities-doped amorphous silicon (n+a—Si:H).

FIG. 1E shows a third mask process. A second metal layer (not shown) is formed on the ohmic contact pattern 24. The second metal layer may include one of aluminum (Al), aluminum alloy (AlNd), chromium (Cr), molybdenum (Mo), tungsten (W), titanium (Ti) and copper (Cu). The second metal layer (not shown) is etched using a third mask (not shown) as an etching mask to form a source electrode 26 and a drain electrode 28 on the ohmic contact pattern 24. The source and drain electrodes 26 and 28 are separated from each other to expose the ohmic contact pattern 24 between the source and drain electrodes 26 and 28. The ohmic contact pattern 24 between the source and drain electrode 28 is removed to form an ohmic contact layer 25 and expose the active layer 22 between the source and drain electrodes 26 and 28. The active layer 22 that is exposed between the source and drain electrodes 26 and 28 is defined as a channel region.

FIG. 1F shows a fourth mask process. As shown in FIG. 1F, a passivation layer 30 is formed on an entire surface of the substrate including the source and the drain electrodes 26 and 28. The passivation layer 30 includes an inorganic insulating material, such as silicon oxide (SiO₂) or silicon nitride (SiNx), or includes an organic insulating material, such as benzocyclobutene (BCB) or an acryl resin. The passivation layer 30 is patterned using a fourth mask (not shown) as a patterning mask to form a drain contact hole 32 exposing the drain electrode 28.

FIG. 1G shows a fifth mask process. A transparent conductive material layer (not shown) is formed on the passivation layer 30 and etched using a fifth mask (not shown) as an etching mask to form a pixel electrode 34. The pixel electrode 34 contacts the drain electrode 28 through the drain contact hole 32. The transparent conductive material layer may include indium-tin-oxide (ITO) or indium-zinc-oxide (IZO).

The TFT and the pixel electrode connected thereto may be fabricated by the above-mentioned processes. As shown above, the fabricating process of the TFT requires several mask processes. The mask processes may include a step of coating the PR layer, a step of exposing the PR layer using a mask, a step of developing the PR layer, a step of removing the PR layer to form the PR pattern, a step of removing a material layer exposed by the PR pattern, and so on. Accordingly, production costs increase and production yields decrease due to the complicated mask processes.

### SUMMARY

In a first aspect, a method for fabricating a soft mold includes preparing a master plate including at least one pattern. A resin layer is disposed on the master plate over the at least one pattern. A back-plane is contacted with the resin layer in a substantially vacuum environment and the resin layer is cured. The resin layer is detached from the master plate.

In a second aspect, a method for fabricating a soft mold includes providing a master plate with an embossed pattern and disposing a resin layer on the master plate over the embossed pattern. The master plate with the resin layer is inserted on a movable stage in a chamber. An adhesive material is applied on a back plane and the stage with the master plate is moved towards the back plane to contact the resin layer and the back plane with the adhesive material. The contact of the resin layer and the back plane occurs while the chamber has a substantially vacuum environment. The resin layer is cured and detached with the back plane from the master plate and the soft mold comprises the cured resin layer.

In a third aspect, a fabrication apparatus includes a chamber and a back plane disposed in the chamber. A master plate is configured to fabricate a soft mold with a plurality of patterns. A stage within the chamber is configured to receive the master plate. A resin layer is disposed on the master plate. The stage is configured to allow the back plane to attach with the resin layer on the master plate while the chamber has a substantially vacuum environment.

It is to be understood that both the foregoing general description and the following detailed description of the present invention are exemplary and explanatory and are intended to provide further explanation of the invention as claimed. Other systems, methods, features and advantages will be, or will become, apparent to one with skill in the art upon examination of the following figures and detailed description. Nothing in this section should be taken as a limitation on those claims. Further aspects and advantages are discussed below in conjunction with the embodiments. Additional features and advantages of the embodiments will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

The system and/or method may be better understood with reference to the following drawings and description. Non-limiting and non-exhaustive embodiments are described with reference to the following drawings. The components in the figures are not necessarily to scale, emphasis instead being placed upon illustrating the principles of the invention. In the figures, like referenced numerals designate corresponding parts throughout the different views. The accompanying drawings, which are included to provide a further understanding of the invention and are incorporated in and constitute a part of this specification, illustrate embodiments of the invention and together with the description serve to explain the principles of the invention.

FIGS. 1A to 1G are cross-sectional views showing a fabricating process of a thin film transistor (TFT) according to the related art.

FIGS. 2A to 2D are cross-sectional views showing a fabricating process of a soft mold according to one embodiment.

FIG. 3 is a flow chart for explaining a fabricating process of a soft mold according to one embodiment.

FIG. 4 is a schematic cross-sectional view showing an apparatus for fabricating a soft mold according to one embodiment.

FIGS. 5A to 5F are cross-sectional views illustrating a method of forming a pattern using a soft mold according to one embodiment.

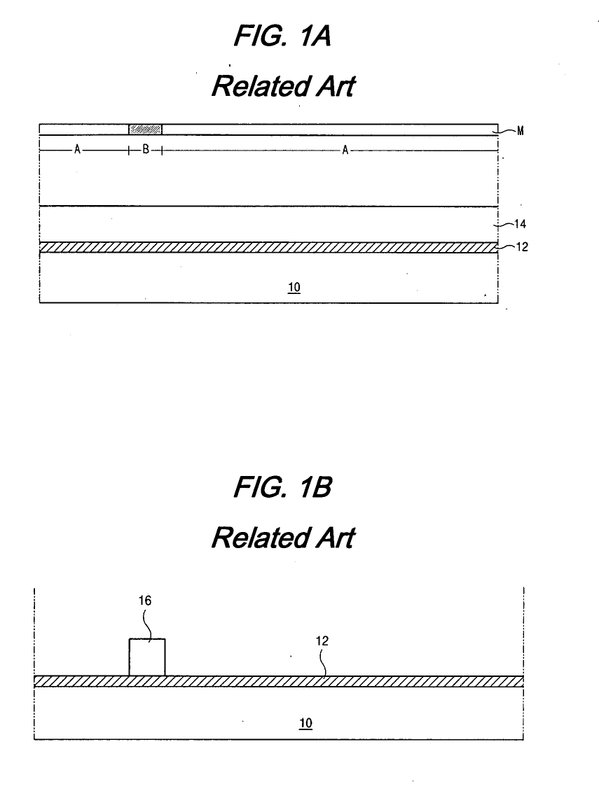

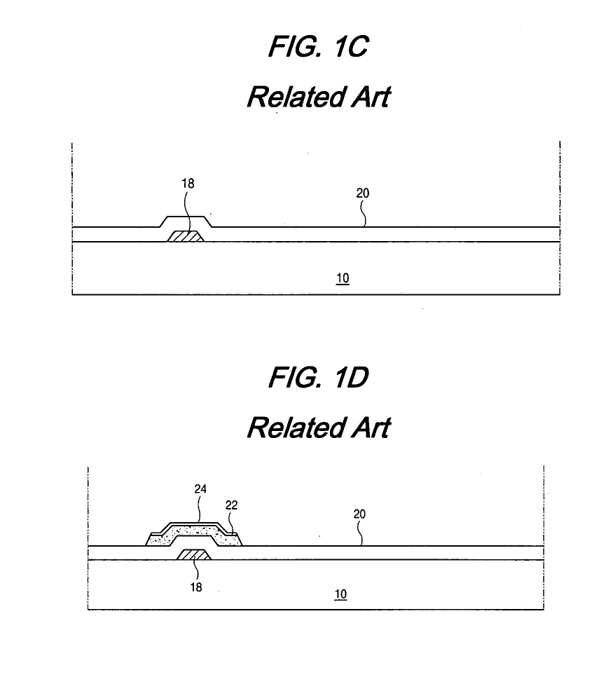

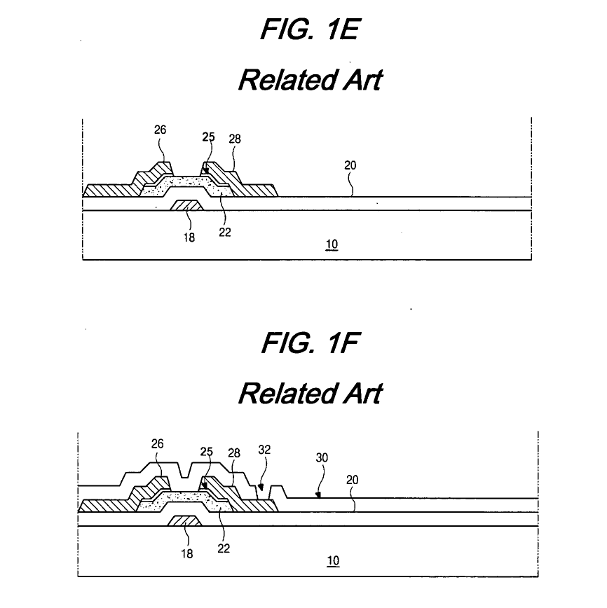

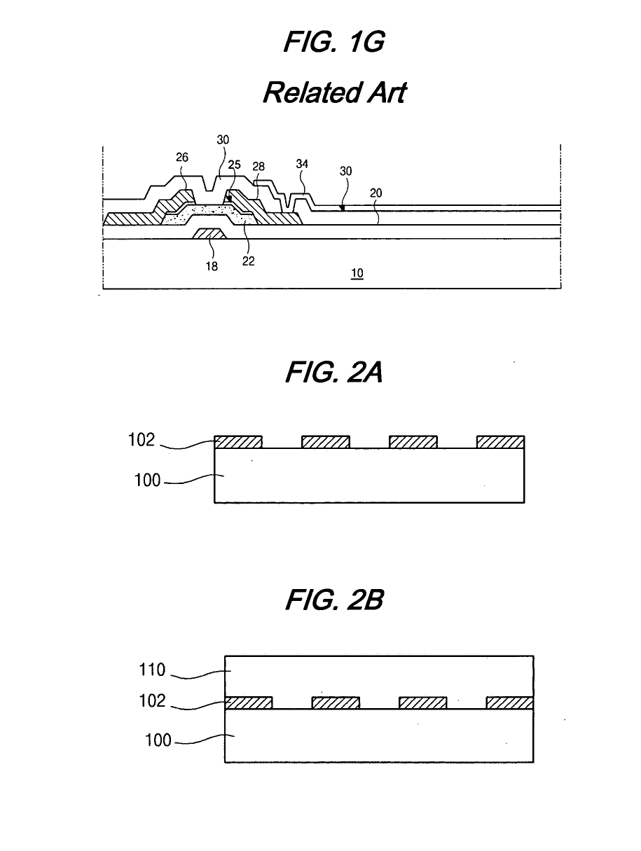

### DETAILED DESCRIPTION OF THE EMBODIMENTS

Reference will now be made in detail to the embodiments, examples of which are illustrated in the accompanying drawings.

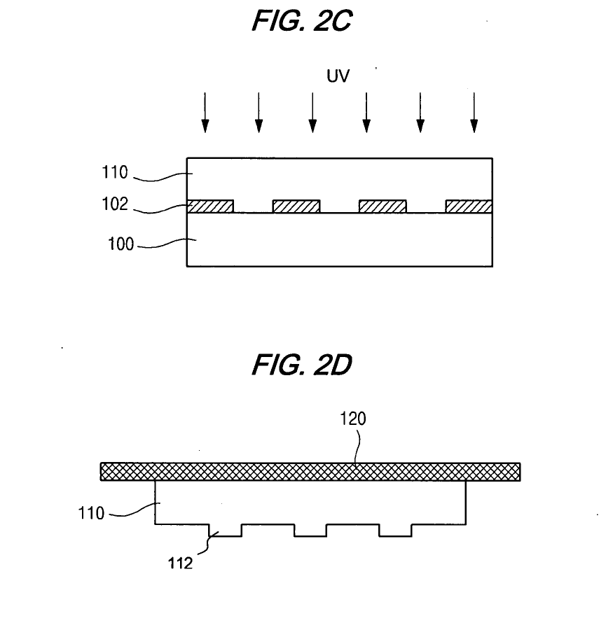

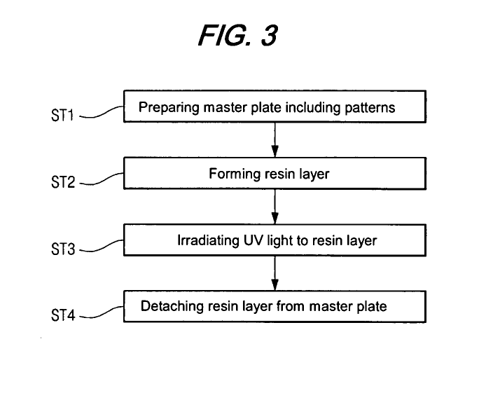

FIGS. 2A to 2D are cross-sectional views showing a fabricating process of a soft mold according to one embodiment, and FIG. 3 is a flow chart showing a fabricating process of a soft mold according to one embodiment. The soft mold is fabricated by coating a resin material layer on a master substrate, which having one of an embossed pattern and a depressed pattern, and hardening or curing the resin material layer using ultraviolet (UV) light.

As shown in FIG. 2A and FIG. 3, a plurality of embossed patterns 102 are formed on the master plate 100 at block ST1. A plurality of depressed patterns instead of the plurality of embossed patterns 102 may be formed on the master plate 100. The plurality of embossed patterns 102 may be formed of a same material as the master plate 100 or a different material from the master plate 100. The master plate 100 is formed of silicon (Si), and the embossed patterns 102 are formed of one of Si, a metallic material, a PR material, wax, silicon nitride (Si₃N₄) and silica (SiO₂).

As shown in FIG. 2B and FIG. 3, a resin layer 110 is formed on the plurality of embossed patterns 102 at block ST2. The resin layer 110 is formed of a liquid phase polymer precursor having photo-curable properties. For example, the resin layer 110 may include polyurethane acrylate, glycidyl acrylate or butyl methacrylate. When glycidyl acrylate or butyl methacrylate is used, a photo-initiator, such as Irgacure 369 or Irgacure 819, may be added. The resin layer 110 is formed on the master plate 100 using a spin coating method or a slit coating method. The thickness of the resin layer 110 may be modified depending on requirements for the mold.

As shown in FIG. 2C and FIG. 3, the resin layer 110 is cured by irradiating UV light at block ST3. Since the resin layer 110 is cured by the UV light, damage on the resin layer 110 is minimized. Accordingly, the resin layer 110 may be formed to be thin because the resin layer is not deformed from the heat of a heat-curable process. Additionally, the UV curable resin has a relatively low viscosity, which allows for the resin layer 110 to have a relatively thin thickness. In addition, a heat curing process may take about one hour, while a UV curing process may take less than one minute. Generally, the lifetime of a UV cured mold is greater than the lifetime of a heat cured mold.

As shown in FIG. 2D and FIG. 3, the resin layer 110 that is cured by the UV light is detached from the master plate 100 at block ST4. A back-plane 120 may be used for detaching the resin layer 110 from the master plate 100. The back-plane 120 may be attached the resin layer 110 using adhesives (not shown). With the resin layer 110 attached to the back-plane 120, the back-plane 120 may be detached from the master plate 100. The resin layer 110 detached from the master plate 100 has a plurality of counter patterns 112 from the plurality of embossed patterns. The back-plane 120 may be formed of a transparent material, such as glass, quartz, polyethyleneterephthalate (PET), polymethylmethacrylated (PMMA), or polycarbonate (PC). In one example, the adhesive may be EC-2320 of 3M Co., Ltd. The adhesive may be formed on the back-plane 120 by a spray coating method, a spin coating method, a slit coating method or a bar coating method. As described, the fabricating process of the soft mold may be beneficially performed under a vacuum to prevent deterioration.

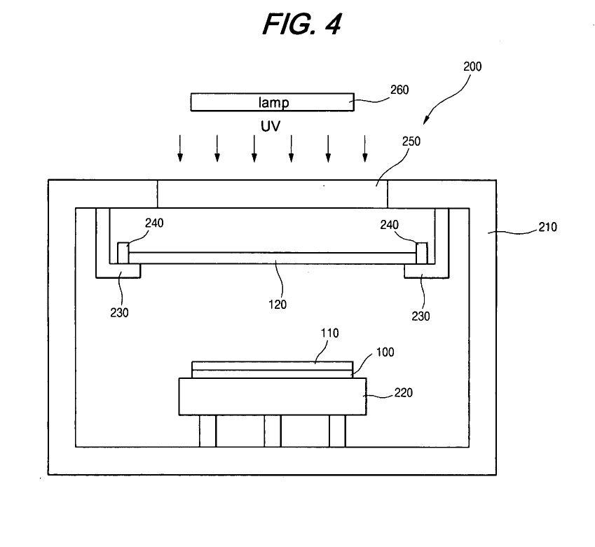

FIG. 4 is a schematic cross-sectional view showing an apparatus for fabricating a soft mold according to one embodiment. The apparatus 200 for fabricating a soft mold includes a chamber 210 and a UV lamp 260. The UV lamp 260 is disposed over the chamber 210. A transparent window 250 is disposed near an upper wall of the chamber 210. The transparent window 250 may be formed of glass or quartz, such that the UV light emitted from the UV lamp 260 may pass through the transparent window 250. A stage 220 and a jig 230 are coupled with the chamber 210. The master plate 100, on which the resin layer 110 is formed, is disposed on the stage 220. The stage 220 may be adjustable to move up and down or left and right relative to the chamber 210. To move the stage 220, a motor (not shown) may be disposed adjacent to the chamber 210 and configured to move the stage 220. Accordingly, the master plate 100 on the stage can move up and down or right and left. The stage 220 includes a vacuum plate so that the master plate 100 may move without changing the position on the stage 220. The jig 230 is disposed over the stage 220 and configured to receive the back-plane 120. The back-plane 120 is disposed on or coupled with the jig 230. The back-plane 120 may be fixed to the jig 230 by a fixing unit 240. The jig 230 may also be adjustable and configured to move up and down. To move the jig 230, a motor (not shown) may be formed adjacent to the chamber 210 and coupled with the jig 230. Although not shown, the adhesives may be formed on the back-plane 120. In addition, a camera may be disposed adjacent to the transparent window 250 to observe the chamber 210 and the process inside the chamber 210.

The apparatus as shown in FIG. 4 may be used in a fabricating process of a soft mold. The master plate 100, on which the resin layer 110 is disposed, is transported into the chamber 210 and disposed onto or adjacent the stage 220. The inside of the chamber 210 may be substantially a vacuum. The master plate 100 is aligned with the back-plane 120 by moving the stage 220 left and right or forward and backward. As discussed above, the stage 220 includes a vacuum plate to stabilize the master plate 100 onto the stage 220. Accordingly, the master plate 100 can move without altering the position on the stage 220. The master plate 100 includes the plurality of embossed patterns 102 (of FIG. 2A) at a surface thereof. A surface of the resin layer 110 is embossed and depressed due to the plurality of embossed patterns 102.

The stage 220 may move upward, so that the back-plane 120 contacts the resin layer 110. An adhesive (not shown) is formed on or disposed on a surface of the back-plane 120. The surface of the back-plane 120 with the adhesive contacts the resin layer 110, so that the back-plane 120 is attached to or coupled with the resin layer 110. In one embodiment, the substantially vacuum condition may be maintained until after the soft mold and back plane 120 are detached from the master plate 100. In another embodiment, the substantially vacuum condition may be removed after the surface of the back-plane 120 is contacted with the resin layer 110. For example, the substantially vacuum condition may be removed with a blowing process using an inert gas, such as nitrogen or argon. The resin layer 110 may then be cured, such as through a heat curing process or an ultraviolet light curing process. As shown in the embodiment of FIG. 2C, an ultraviolet light curing process is used.

In the ultraviolet curing process, a UV lamp 260 emits UV light that is irradiated to the resin layer 110 through the transparent window 250 and through the back-plane 120 to cure the resin layer 110. With the resin layer 110 attached to the back-plane 120, the stage 220 moves downward, so that the resin layer 110 with the back-plane 120 is detached from the master plate 100. In alternative embodiments, it is possible to move the back-plane 120 instead of the stage 220 to detach the resin layer 110.

Since the plurality of embossed patterns 102 (of FIG. 2A) are formed on the master plate 100, the resin layer 110 detached from the master plate 100 has a plurality of counter patterns 112 (shown in FIG. 2D) from the plurality of embossed patterns 102. After being detached, the resin layer 110 with the back-plane 120 may be transported into a chamber for the next process. The above-mentioned processes or parts of the above-mentioned process may be performed under a vacuum or an environment substantially similar to a vacuum in the chamber.

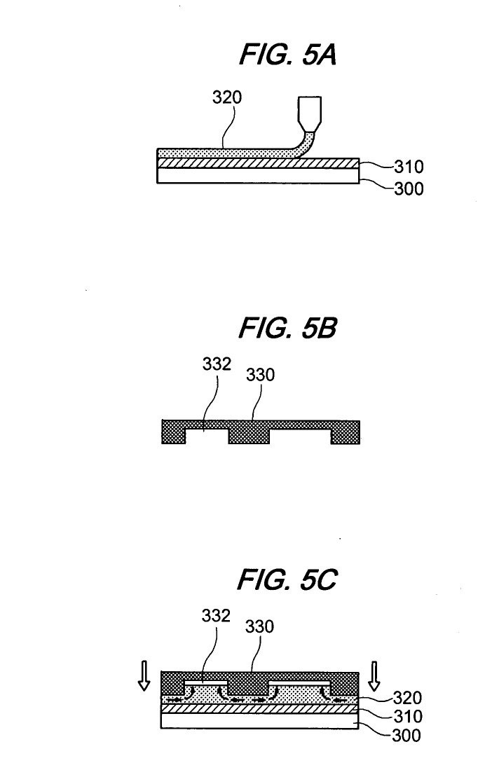

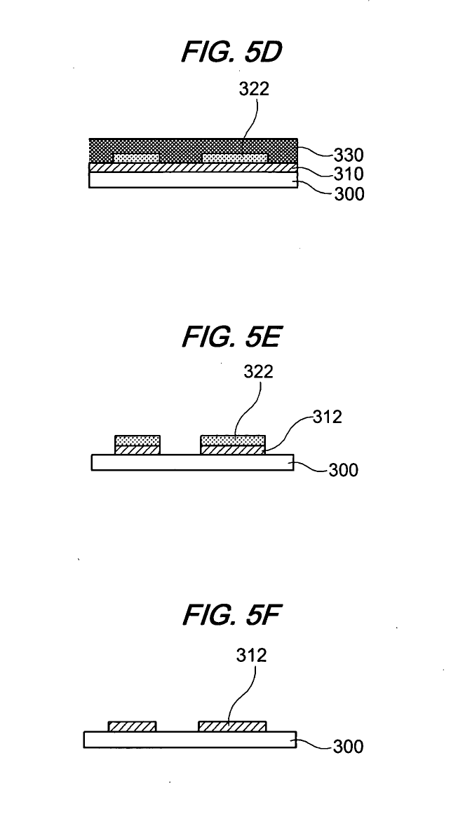

A method of forming a pattern using the soft mold will be described hereinafter with reference to the accompanying drawings. In particular, FIGS. 5A to 5E are cross-sectional views illustrating the forming of a pattern using a soft mold according to one embodiment.

In FIG. 5A, a thin film 310 is formed on a substrate 300, and a resist 320 is applied to the thin film 310. The thin film 310 may be formed of a metallic material for electrodes of a thin film transistor (TFT), amorphous silicon material for an active layer or an ohmic contact layer of the TFT, or an insulating material, such as silicon nitride and silicon oxide.

In FIG. 5B, a soft mold 330, which has depressed patterns 332 at a surface thereof may be developed. In one embodiment, the soft mold 330 may be developed as described above in FIGS. 2-4. Alternatively, the soft mold may be generated by other techniques.

In FIG. 5C, a soft mold 330, which has depressed patterns 332 at a surface thereof, is disposed on the thin film 310 such that the depressed patterns 332 are adjacent to or face the thin film 310. The soft mold 330 may have a hydrophobic property, and the resist 320 may have a hydrophilic property. The resist 320 is drawn into the depressed patterns 332 due to a repulsive force between the soft mold 330 and the resist 320. A top surface of the soft mold 330 contacts the thin film 310.

In FIG. 5D, the resist 320 in the depressed patterns 332 is cured by UV light to form resist patterns 322. The soft mold 330 may be detached from the substrate 300 including the resist patterns 322 thereon. In FIG. 5E, the thin film 310 of FIG. 5C is selectively etched using the resist patterns 322 as an etching mask to form desired patterns 312. In FIG. 5F, the resist patterns 322 are removed, leaving the desired patterns 312 on the substrate 300. Accordingly, a thin film transistor (TFT) or an array substrate including the thin film transistors may be manufactured by performing the processes discussed above in FIGS. 5A to 5F.

As described, the soft mold is cured by UV light and is prevented from being transformed and damaged. Additionally, the soft mold may have relatively a thin thickness and light-weight.

It will be apparent to those skilled in the art that various modifications and variations can be made in the fabrication apparatus for a soft mold and a method of fabricating a soft mold using the same of the present embodiments without departing from the spirit or scope of the invention. The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive. The above disclosed subject matter is to be considered illustrative, and not restrictive, and the appended claims are intended to cover all such modifications, enhancements, and other embodiments, which fall within the true spirit and scope of the present invention.

What is claimed is:

1. A method for fabricating a soft mold comprising:
preparing a master plate including at least one pattern;
disposing a resin layer on the master plate over the at least one pattern;
contacting a back-plane with the resin layer in a substantially vacuum environment;
curing the resin layer; and
detaching the resin layer from the master plate.

2. The method of claim 1 wherein the at least one pattern includes at least one of an embossed pattern, a depressed pattern, or combinations thereof.

3. The method of claim 1 further comprising blowing an inert gas to remove the substantially vacuum environment after contacting the back plane with the resin layer.

4. The method of claim 1 wherein the substantially vacuum environment is maintained for the curing and detaching processes.

5. The method of claim 1 wherein the steps of contacting, curing and detaching occur in a chamber.

6. The method of claim 5 further comprising inserting the master plate with the resin layer into the chamber before contacting the back plane with the master plate.

7. The method of claim 1 wherein the master plate is formed of silicon and the embossed pattern is formed of one of silicon, a metallic material, a photo-resist material, wax, silicon nitride, or silica.

8. The method of claim 1 wherein the resin layer comprises a liquid phase polymer before the curing of the resin layer.

9. The method of claim 1 wherein the disposing of the resin layer comprises one of a spin coating method or a slit coating method.

10. The method of claim 1 wherein the curing comprises irradiating light on the resin layer.

11. The method of claim 1 wherein the contacting of the back-plane to the resin layer further comprises applying an adhesive to a surface of the back-plane.

12. The method of claim 1 wherein detaching the resin layer from the master plate leaves at least one counter pattern corresponding to the at least one pattern on the master plate.

13. The method of claim 1 wherein the resin layer comprises at least one of a polyurethane acrylate, a glycidyl acrylate or a butyl methacrylate.

14. The method of claim 1 wherein a photo-initiator is added to the resin layer.

15. A method for fabricating a soft mold comprising:
providing a master plate with an embossed pattern;
disposing a resin layer on the master plate over the embossed pattern;
inserting the master plate with the resin layer on a movable stage in a chamber;
applying an adhesive material on a back plane;
moving the stage with the master plate towards the back plane to contact the resin layer and the back plane with the adhesive material, wherein the contact of the resin layer and the back plane occurs while the chamber has a substantially vacuum environment;
curing the resin layer; and
detaching the resin layer and the back plane from the master plate, wherein the soft mold comprises the cured resin layer.

16. The method of claim 15 wherein the curing the resin layer comprises applying ultraviolet light to the resin layer.

17. The method of claim 15 further comprising blowing an inert gas to remove the substantially vacuum environment after moving the stage with the master plate towards the back plane to contact the resin layer and the back plane.

18. The method of claim 15 wherein the disposing of the resin layer comprises one of a spin coating method or a slit coating method.

19. The method of claim 15 wherein detaching the resin layer from the master plate leaves at least one counter pattern corresponding to the at least one pattern on the master plate.

20. A fabrication apparatus comprising:
a chamber;
a back plane disposed in the chamber;
a master plate configured to fabricate a soft mold with a plurality of patterns;
a stage within the chamber and configured to receive the master plate; and
a resin layer disposed on the master plate;
wherein the stage is configured to allow the back plane to attach with the resin layer on the master plate while the chamber has a substantially vacuum environment.

21. The fabrication apparatus of claim 20 further comprising a lamp, wherein the chamber includes a transparent window configured to receive light from the lamp.

22. The fabrication apparatus of claim 21 wherein the light from the lamp is configured to cure the resin layer.

23. The fabrication apparatus of claim 20 wherein the stage is configured to move towards the back plane, such that the resin layer is contacted with the back plane due to the movement of the stage.

24. The fabrication apparatus of claim 20 wherein the back plane is disposed in the chamber with at least one jig coupled with the chamber and at least one fixing unit coupled with the at least one jig and configured to stabilize the back plane.

25. The fabrication apparatus of claim 20 wherein the plurality of patterns comprise a plurality of embossed patterns that are formed on the master plate.

26. The fabrication apparatus of claim 25 wherein a plurality of counter patterns are formed on the resin layer corresponding with the plurality of embossed patterns from the master plate.
